(19) United States
(12) Patent Application Publication
(10) Pub. No.: US 2005/0218747 A1
(43) Pub. Date: Oct. 6, 2005

(54) Electric machine

(76) Inventors: Heiko Sponar, Rastatt (DE); Juergen Herp, Buehl (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/517,230

(22) PCT Filed: Mar. 10, 2003
(86) PCT No.: PCT/DE03/00752

§ 371 Date: Dec. 8, 2004

(30) Foreign Application Priority Data
Jul. 12, 2002 (DE) 102 31 596.5

(51) Int. Cl. H02K 3/48

(52) U.S. Cl. 310/214

(57) ABSTRACT

An electrical machine with a rotor attached to a shaft and a multi-part stator having a yoke ring and stator fins that delimit winding grooves, which accommodate windings or winding segments wound around insulator elements. The stator has a number of first wound insulator elements that are wound one after another with the same first winding wire and a number of second insulator elements that are wound one after another with the same second winding wire.

### PRIOR ART

The invention relates to an electrical machine with a rotor attached to a shaft and a multi-part stator that has a yoke ring and stator fins that delimit winding grooves, which accommodate windings or winding segments wound around insulator elements.

There are known brushless electric motors in which the windings are mounted on the stator. Electric motors of this kind include so-called asynchronous, synchronous, or EC motors (EC: electronically commutated). In these electric motors, the stator is comprised of layers of individual stator laminations and the windings are wound onto insulator elements arranged around this stator. Since a number of windings are disposed on a stator, there is a wire beginning and wire end for each individual winding. Since electric motors of this kind have a number of windings, they require expensive and complex interconnection grids that connect the wire ends of the individual windings to the power supply lines for these windings. This results in the presence of countless contact points, which influence both the manufacturing steps in the production of the electric motor and also the susceptibility of the electric motor to malfunction.

### ADVANTAGES OF THE INVENTION

The object of the current invention is to provide an electrical machine, which is particularly easy to manufacture and no longer requires complex interconnection grids for the windings.

This object is attained by means of the features of the independent claim 1. According to this claim, the stator has a number of first wound insulator elements that are wound one after another with the same first winding wire and a number of second insulator elements that are wound one after another with the same second winding wire.

The invention is based on the recognition that using one winding wire on a number of insulator elements, which are arranged one after another and serve as winding bodies, makes it possible to significantly reduce the number of winding wire ends. For example in a brushless EC electric motor, three winding packets that are offset from one another can be used to generate the electromagnetic rotary field. To that end, an alternating sequence starting with an insulator element of the first winding packet, then the second insulator element of the next winding packet and finally the third insulator element of the third winding packet can be disposed one after another on the stator, which are then followed by the first wound insulator element of the first winding packet and so forth. The insulator elements of the first winding packet are then continuously wound with the same first winding wire so that the first winding packet has only two wire ends.

The essence of the invention lies in reducing the number of the wire ends by using the same uninterrupted first winding wire for a number of insulator elements. This produces concatenated coil bodies in the form of insulator elements, which are then used together as a winding packet in the stator. In the last insulator element, the wire end is then routed out from the stator. The advantage of the invention lies in minimizing the number of winding wire ends in the stator. For example, with three winding packets, there are six winding wire ends. Depending on the interconnection principle, it is then possible to completely eliminate the use of a complex interconnection grid or else the interconnection grid is significantly simplified. This makes it possible to reduce the motor height of the electric motor. There are fewer contact points between the winding wire and the interconnection grid, which reduces conductivity problems at soldering points. Finally, significantly fewer manufacturing steps are required to produce the electric motor, which reduces the cost of the electric motor.

The insulator elements can be embodied as frame-shaped or ring-shaped coil bodies around which the winding wire is wound into channel-like recesses at the outer edges. The insulator elements thus produced can then be slid around or onto stator fins of the electric motor or onto pins of the stator. To that end, the stator is preferably comprised of a number of parts, an annular yoke ring holding the stator together and constituting the path for the electromagnetic flux. Inside or outside the yoke ring, a toothed ring can be provided so that each tooth constitutes a stator fin. Between the stator fins and possibly the yoke ring, winding grooves are formed, which accommodate winding segments or the entire winding. As an alternative to the toothed ring, it is also possible for the stator fins to be comprised of individual teeth, the individual teeth then being fastened to the yoke ring.

The stator fins of the stator are preferably designed to fit the frame-shaped or ring-shaped insulator elements so that the insulator elements with the windings can be attached to the stator fins with form-fitting engagement. If a toothed ring is provided inside the yoke ring, then the frame-shaped insulator elements with the winding disposed around them can be slid on around the tooth-shaped stator fins. In this way, one winding half is disposed on one side of the tooth-shaped stator fin and the other winding half is disposed on the other side of the stator fin. The insulator bodies with the windings thus embrace the stator fins in this embodiment form. In the simplest instance, one frame-shaped insulator element is slid on for each stator fin of the toothed ring. For example, if there are three winding packets, each with three insulator elements, then nine tooth-shaped stator fins are provided on the toothed ring. With this division principle on the stator, an individual insulator element serving as a coil body can be slid onto each corresponding tooth and the winding ends of each winding packet are then connected to the power supplies via a simple interconnection grid.

In a modification of the invention, the multi-part stator of the electric motor is embodied as a hollow, cylindrical yoke ring and a toothed ring concentric to it is disposed inside the yoke ring. A number of insulator elements provided with one winding wire are then attached to the toothed ring provided on the inside. The toothed ring constitutes a one-piece stator part and, with the insulator elements attached to it, is affixed to the yoke ring. The insulator elements can have detent projections on one side to allow them to be fastened to one of the teeth, to the stator fins, or to the stator of the electric motor.

In the manufacturing process of the stator for the electric motor, the winding wire is wound clockwise or counterclockwise around a first insulator element and the first winding wire is then wound in the same winding direction around the following insulator element. This winding process is continued until all of the insulator elements of the winding packet have been wound with the first winding wire.

To this end, a number of the insulator elements are placed in a winding machine so that this machine can wind the insulator elements one after another until a winding packet is completed. Then the second winding packet is completely wound with a second winding wire and so forth. After the winding, the insulator elements, which are interconnected in this manner and serve as coil bodies, are slid onto the stator fins or stator teeth and the stator is assembled. In this case, a toothed ring, which has the insulator elements with the winding disposed on them slid onto it, can be inserted into a yoke ring and fastened there. Now, the winding wire ends can be connected to one another and to the power connections by means of a simple interconnection grid. This method can produce an electric motor that is compact in height since complex interconnection grids have been eliminated and the windings are disposed inside winding grooves in the stator.

The invention is particularly related to brushless electric motors such as asynchronous, synchronous, or EC motors. A particular design of the stator has been described according to the invention; it is, however, equally possible for the invention to be used in alternating current motors and direct current motors, provided they have a stator winding.

### DRAWINGS

The invention will be explained in detail below in conjunction with a number of embodiment forms of the electric motor.

FIG. 1 shows a schematic view of a first winding packet with three insulator elements and the winding provided according to the invention,

FIG. 2 shows a schematic view of the stator according to the invention, with the winding packet according to FIG. 1 slid onto the stator fins,

FIG. 3 shows a schematic cross-section through two possible stator designs,

FIG. 4 shows a schematic depiction of how three insulator elements are positioned when being wound in a winding machine, and

FIG. 5 shows a schematic top view of the winding wire ends and the windings on the respective insulator elements of a first winding packet.

### DESCRIPTION OF THE EXEMPLARY EMBODIMENTS

The stator 1 of the electrical machine, which can be an electric motor or a generator, has a yoke ring 2 that bounds the stator 1 on its outside in the exemplary embodiment shown. Inside the yoke ring 2, the toothed ring 3 is provided, whose teeth constitute stator fins 4. Disposed around the stator fins 4, there are three insulator elements 5, 6, 7, which together constitute a first winding packet.

Between the outer yoke ring 2 of the stator 1 and the nine stator fins 4 provided in this embodiment form, winding grooves 8 are provided, which respectively accommodate the winding wires wound around the insulator elements 5, 6, 7. The stator 1, the yoke ring 2, and the toothed ring 3 can be comprised in layers of stator lamination bundles in the conventional way.

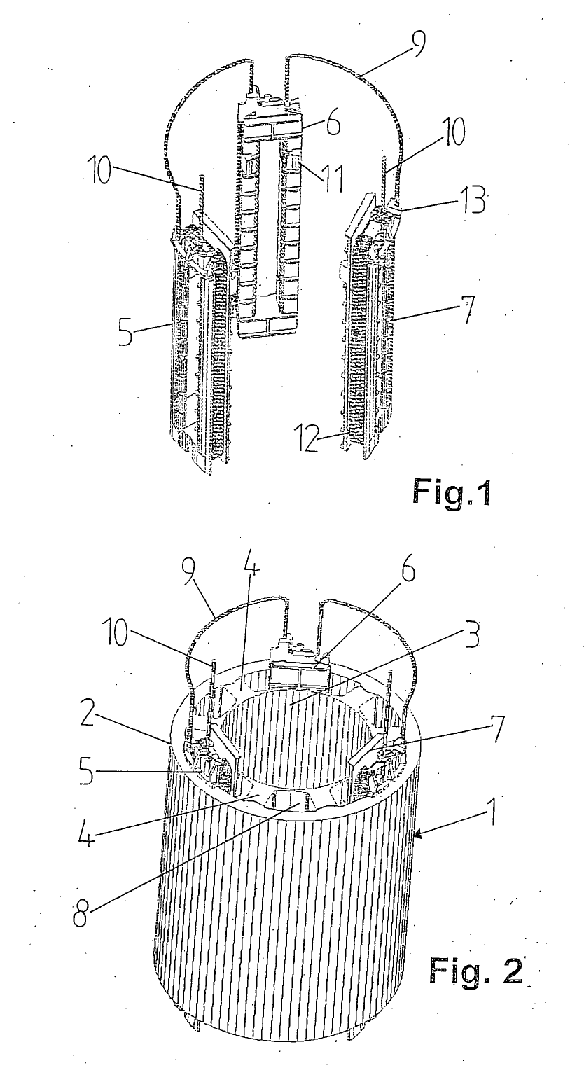

As is clearly shown in FIG. 1, viewed from inside out, the winding wire 9 is wound in the same direction, for example counterclockwise, around the three insulator elements 5, 6, 7 of the first winding packet. Starting from the winding wire end 10, the winding passes around the first insulator element 5 a number of times and is then routed without interruption to the second insulator element 6, where the winding wire 9, viewed from inside, is wound in the same winding direction around the insulator element 6. Then, the winding wire 9 is routed to the third insulator element 7 of the first winding packet and is also wound around it in the same direction. The insulator elements are embodied as frame-shaped; they are provided with an internal recess that fits with form-fitting engagement onto the stator fins 4 of the toothed ring 3. Detent projections 11 are provided on the insulator elements 5, 6, 7 in order to affix them to the stator 1 once they are installed. At their outer edge, the insulator elements 5, 6, 7 are provided with channel-like recesses 12 for the winding wire 9 so that this winding wire 9 is held in position once it has been wound on. The insulator elements 5, 6, 7 also have wire guide elements 13, which guide the winding wire 9 in the provided direction to the next insulator element 6 or 7.

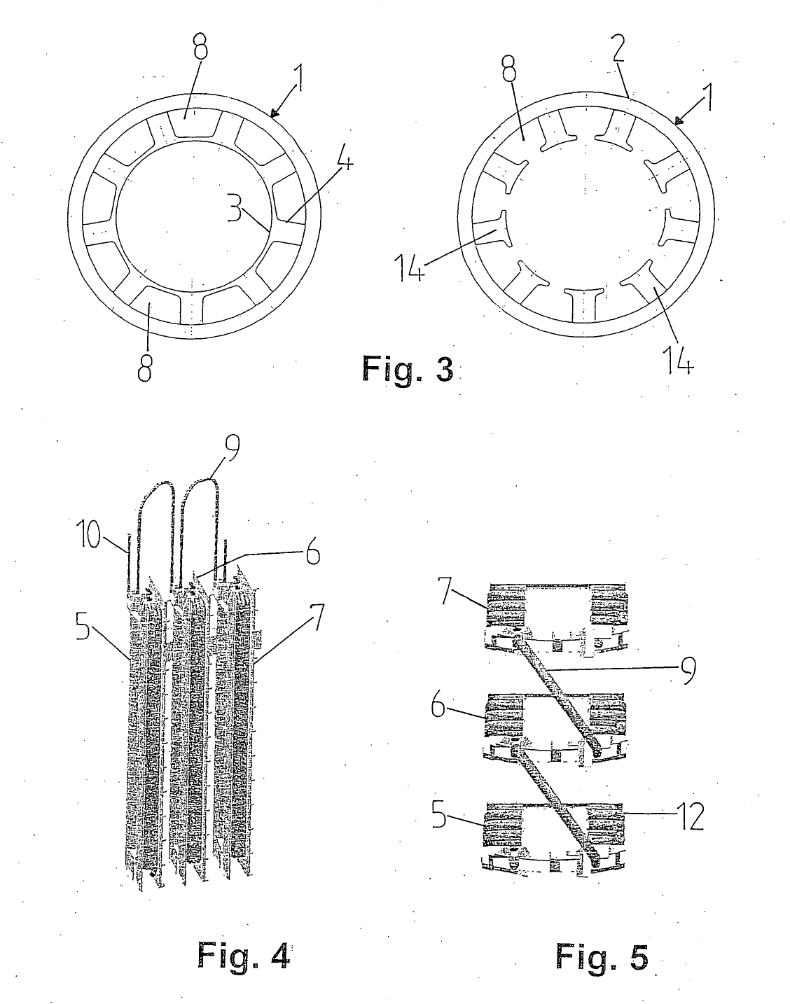

FIG. 3 shows cross-sectional views of two embodiment forms for the stator according to the invention. The depiction of the left shows the stator 1 with the toothed ring 3 and the stator fins 4 constituted by the teeth of the toothed ring 3 and how these form the winding grooves 8. The toothed ring 3 is disposed concentrically inside the yoke ring 2. The depiction on the right side of FIG. 3 shows an alternative embodiment form of the stator 1 with individual teeth 14. The individual teeth 14 are fastened inside the yoke ring 2, likewise producing winding grooves 8 between the teeth 14 so that windings or winding parts are disposed in each of these winding grooves 8. The insulator elements 5, 6, 7 are placed around these teeth 14 and, during assembly of the stator 1, are slid completely into the yoke ring 2 along its longitudinal axis.

FIG. 4 shows the wound insulator elements 5, 6, 7 and how they are inserted into a winding machine. As a result, the winding machine can wind the one-piece winding wire 9 in the winding direction around all three insulator elements 5, 6, 7 of the first winding packet at the same time. The winding wire 9 is cut only at the end of the winding process and the winding machine then winds the insulator elements for the next winding packet and so forth.

Finally, FIG. 5 shows another top view of the winding disposed on the insulator elements 5, 6, 7. If the winding packet is wound in the winding machine according to this depiction, then in the subsequent assembly process, it can be placed very simply onto the stator fins 4, 14 of the stator 1 and then, together with the toothed ring 3, can be inserted into the yoke ring 2. As is clear from FIG. 5, this winding process makes it very easy to check for proper winding of the stator 1. A breakage of the winding wire 9, particularly at the transitions between the insulator elements 5, 6, 7, can be easily detected by means of a visual control.

In order to completely finished the stator 1, the insulator elements 5, 6, 7 of the first winding packet are placed one after another into the stator 1 shown in FIG. 2, and are respectively followed by the three insulator elements of the second winding packet, each offset to the right by one stator fin 4, and finally, the three insulator elements of the third winding packet are placed onto the toothed ring 3, each offset by one stator fin 4. Then, the wound insulator elements 5, 6, 7, together with the toothed ring 3, are inserted into the yoke ring 2 and fastened there.

The stator 1 produced in this manner has a very low number of winding wire ends 10 and for this reason, as well as due to the arrangement of the insulator elements 5, 6, 7 according to the invention, can be very compactly designed.

1-10. (canceled)

11. In an electrical machine with a rotor attached to a shaft and a multi-part stator (1) that has a yoke ring (2) and stator fins (4, 14) that delimit winding grooves (8), which winding grooves accommodate windings (9) or winding segments wound around insulator elements (5, 6, 7), the improvement wherein the stator (1) comprises a number of first wound insulator elements (5, 6, 7) that are wound one after another with the same first winding wire (9) and a number of second insulator elements that are wound one after another with the same second winding wire.

12. The electrical machine according to claim 11, wherein the insulator elements (5, 6, 7) are frame-shaped or ring-shaped coil bodies that can be slid around or onto stator fins (4) or onto teeth (14) of the stator (1).

13. The electrical machine according to claim 11, wherein the stator fins (4, 14) of the stator (1) are designed to fit the frame-shaped or ring-shaped insulator elements (5, 6, 7) so that the insulator elements (5, 6, 7) with the windings (9) can be fastened to the stator fins (4, 14) with form-fitting engagement.

14. The electrical machine according to claim 12, wherein the stator fins (4, 14) of the stator (1) are designed to fit the frame-shaped or ring-shaped insulator elements (5, 6, 7) so that the insulator elements (5, 6, 7) with the windings (9) can be fastened to the stator fins (4, 14) with form-fitting engagement.

15. The electrical machine according to claim 11, wherein the multi-part stator (1) comprises a hollow, cylindrical yoke ring (2) and a toothed ring (3) concentric to it, whose teeth (14) constitute the stator fins to which the insulator elements (5, 6, 7) can be fastened.

16. The electrical machine according to claim 12, wherein the multi-part stator (1) comprises a hollow, cylindrical yoke ring (2) and a toothed ring (3) concentric to it, whose teeth (14) constitute the stator fins to which the insulator elements (5, 6, 7) can be fastened.

17. The electrical machine according to claim 11, wherein a number of insulator elements (5, 6, 7) provided with winding wire (9) can be fastened to a stator part (3) and that the stator part (3) with the insulator elements (5, 6, 7) fastened to it can be attached to the yoke ring (2).

18. The electrical machine according to claim 13, wherein a number of insulator elements (5, 6, 7) provided with winding wire (9) can be fastened to a stator part (3) and that the stator part (3) with the insulator elements (5, 6, 7) fastened to it can be attached to the yoke ring (2).

19. The electrical machine according to claim 15, wherein a number of insulator elements (5, 6, 7) provided with winding wire (9) can be fastened to a stator part (3) and that the stator part (3) with the insulator elements (5, 6, 7) fastened to it can be attached to the yoke ring (2).

20. The electrical machine according to claim 11, wherein the outer edges of the insulator elements (5, 6, 7) are provided with channel-like recesses (12) for the winding wires (9).

21. The electrical machine according to claim 12, wherein the outer edges of the insulator elements (5, 6, 7) are provided with channel-like recesses (12) for the winding wires (9).

22. The electrical machine according to claim 13, wherein the outer edges of the insulator elements (5, 6, 7) are provided with channel-like recesses (12) for the winding wires (9).

23. The electrical machine according to claim 11, wherein the insulator elements (5, 6, 7) have detent projections (11) on one side in order to permit them to be fastened to the stator (1) of the electric motor.

24. The electrical machine according to claim 12, wherein the insulator elements (5, 6, 7) have detent projections (11) on one side in order to permit them to be fastened to the stator (1) of the electric motor.

25. The electrical machine according to claim 11, wherein the winding wire (9) is wound clockwise or counterclockwise around one insulator element (5) and then is wound in the same winding direction around the subsequent insulator element (6, 7).

26. The electrical machine according to claim 12, wherein the winding wire (9) is wound clockwise or counterclockwise around one insulator element (5) and then is wound in the same winding direction around the subsequent insulator element (6, 7).

27. The electrical machine according to claim 11, wherein the electric motor is embodied as a brushless asynchronous, synchronous, or EC motor.

28. The electrical machine according to claim 15, wherein the electric motor is embodied as a brushless asynchronous, synchronous, or EC motor.

29. The electrical machine according to claim 11, wherein the winding wire ends (10) of the insulator elements (5, 6, 7) that are jointly wound with one winding wire (9) are connected in an electrically conductive manner to power supply lines by means of one or more interconnection grids.

30. The electrical machine according to claim 12, wherein the winding wire ends (10) of the insulator elements (5, 6, 7) that are jointly wound with one winding wire (9) are connected in an electrically conductive manner to power supply lines by means of one or more interconnection grids.
